(19) United States
(12) Patent Application Publication
(10) Pub. No.: US 2017/0238560 A1
(43) Pub. Date: Aug. 24, 2017

(54) CROISSANT PRODUCT HAVING BOTH INTEGRATED AND DISCRETE FLAVORINGS AND METHODS OF MAKING SAME

(71) Applicant: Michael Cameron, McKinney, TX (US)

(72) Inventor: Michael Cameron, McKinney, TX (US)

(21) Appl. No.: 15/227,904

(22) Filed: Aug. 3, 2016

Related U.S. Application Data
(60) Provisional application No. 62/297,946, filed on Feb. 22, 2016.
(60) Provisional application No. 62/304,257, filed on Mar. 6, 2016.
(60) Provisional application No. 62/304,799, filed on Mar. 7, 2016.

(51) Int. Cl. A21D 13/00; A21D 2/36; A21D 15/02; A21D 2/16

(52) U.S. Cl. CPC A21D 13/0058; A21D 2/165; A21D 2/364; A21D 15/02; A21D 2/36

(57) ABSTRACT

The invention is a flavored croissant and method of making same, more specifically, a banana nut croissant, an apple cinnamon walnut croissant, a coconut macadamia croissant and a cherry pecan croissant. The invention is further directed to a flavored croissant product that can be stored frozen.

### CROSS-REFERENCE TO RELATED APPLICATION

This application claims priority to the following provisional applications: U.S. Ser. No. 62/297,946, filed Feb. 22, 2016 entitled: FLAVORED CROISSANT AND METHOD OF MAKING SAME; U.S. Ser. No. 62/304,257, filed Mar. 6, 2016 entitled: FLAVORED BUTTER AND SPREAD USED IN BUTTER LAYER FLAVORED CROISSANT AND METHOD OF MAKING SAME; and U.S. Ser. No. 62/304,799, filed Mar. 7, 2016 entitled: CROISSANT WITH INCORPORATED FRUIT LAYERS AND METHOD OF MAKING SAME, the contents of each of which are incorporated herein by reference.

### FIELD OF THE INVENTION

The invention is generally directed to an edible food product, specifically a croissant product having both integrated flavors and discrete flavors and methods of making same.

### BACKGROUND

A croissant is a buttery, flaky pastry named for its crescent shape form factor. The croissant form factor critically allows the consumer of the product to handle and consume it easily as the shape and texture remains substantially intact while it is being consumed. The crescent shape form factor is obtained by cutting laminated, folded dough substantially in a triangle shape, then rolling the triangle shape from the base to the tip. The cut and shaped composition is then, optionally frozen, and then later “proofed,” allowing the dough to rise, then baked or immediately proofed and baked. Proofing is the final rise of shaped bread dough before baking. It refers to a specific rest period within the more generalized process known as fermentation. Fermentation is a step in creating yeast breads and baked goods where the yeast is allowed to leaven the dough. Fermentation rest periods are not always explicitly named, and can be referred to as “allow dough to rise.” When they are named, terms include “bulk fermentation,” “first rise,” “second rise,” “final proof” and “shaped proof”.

In some embodiments, the tips of the rolled dough are turned inward slightly prior to proofing and baking. Croissants are made of layered yeast-leavened dough. The dough is layered with butter, shortening or other fat layer, rolled out and folded several times in succession, then flat rolled into a sheet. The process results in a layered, flaky texture. The layers of butter or shortening provide a flaky, crisp texture at the surface of the baked products, as well as a honeycomb appearance and tender texture in the interior of the baked products.

The only known “flavored” croissants are those that include crème, paste filled croissants, such as those filled with chocolate crème, berry jam or made with almond flour and either topped with butter cream or injected with almond paste and those that are filled with ingredients such as berry jam, spinach or ham and cheese. Disadvantageously, these “flavored” croissants introduce into the light, airy, flaky croissant, a heavy filling component that detracts from the subtleness and flakiness of the pastry. The inclusion of these heavy components overwhelms the light, delicate texture of the croissant. An example of such a filling for a breakfast pastry can be seen in U.S. Pat. No. 4,612,198 to Wallin, et al.

Thus, it is desirable to have a light, flaky croissant that incorporate subtle, nuanced flavors often associated with savory, complementary breakfast or dessert formulations, and that retains the most desirable characteristics of the croissant. What is further desired is to have a flavored croissant that can be stored frozen with or without being partially proofed before being frozen and that can provide a desirable baked product with or without being thawed or proofed before being baked.

### SUMMARY

The invention is a light, flaky croissant that incorporates savory flavors often associated with breakfast or dessert formulations, such flavors being incorporated into the croissant in the form of both integrated flavor ingredients and discrete flavor ingredients. To optimize the organoleptic qualities of the invention, the invention must contain both the at least one integrated flavor ingredient and the at least one discrete flavor ingredient. The resulting croissant has the structure, texture and flakiness of a croissant with the desired organoleptic properties of a dissimilar breakfast or dessert formulation. The croissant form factor is critical to the invention as it takes advantage of the physiological characteristics of the human hand. The croissant form factor allows the consumer of the product to easily and efficiently hold it and consume as the shape and texture remains substantially intact until it has been consumed. Notably, the final product, prepared using the novel methods of the invention, retains the most desirable texture and appearance characteristics of the croissant until the consumer has consumed the product.

The invention is more specifically embodied in one of a banana nut croissant, an apple cinnamon walnut croissant, a coconut macadamia croissant or a cherry pecan croissant.

An embodiment of the invention includes base ingredients of flour, water, sugar, a leavening agent such as yeast, and a fat source, such as butter, margarine or shortening, and the flavor ingredients include both an integrated flavor ingredient and a discrete flavor ingredient.

For the banana nut flavored croissant invention, the integrated flavor ingredient includes banana extract, banana compound, banana puree, dried banana chips or mashed, ripe bananas, and the discrete flavor ingredient includes chopped walnuts and/or chopped pecans. The croissant form factor of the banana nut flavored croissant invention allows the consumer of the product to handle and consume it easily as the shape and texture remains substantially intact while it is being consumed which disadvantageously is not the case with crumbly banana nut bread.

For the apple cinnamon walnut flavored croissant invention, the integrated flavor ingredient includes apple extract, cooked, softened apples, apple compound, apple puree or apple chips, combined with cinnamon oil, flavoring or powder. The discrete flavor ingredient includes chopped walnuts and/or chopped pecans. The croissant form factor of the apple cinnamon walnut flavored croissant invention allows the consumer of the product to handle and consume it easily as the shape and texture remains substantially intact while it is being consumed which disadvantageously is not the case with crumbly, dripping fruit filling based apple pie.

For the coconut macadamia croissant invention, the integrated flavor ingredient includes coconut extract, coconut compound and/or coconut flakes and the discrete flavor ingredient includes chopped macadamia nuts and/or coconut flakes. The croissant form factor of the coconut macadamia flavored croissant invention allows the consumer of the product to handle and consume it easily as the shape and texture remains substantially intact while it is being consumed which disadvantageously is not the case with crumbly, dripping coconut pie.

For the cherry pecan croissant invention, the integrated flavor ingredient includes cherry extract, cherry compound, and/or cherry flavoring and the discrete flavor ingredient includes chopped pecans. The croissant form factor of the cherry pecan flavored croissant invention allows the consumer of the product to handle and consume it easily as the shape and texture remains substantially intact while it is being consumed which disadvantageously is not the case with crumbly, dripping fruit filling based cherry pie.

### BRIEF DESCRIPTION OF THE DRAWINGS

FIG. 1 is a croissant of the invention;

FIG. 2 is a cross section of a croissant of the invention;

FIG. 3A is a table setting out the ingredients in a banana nut embodiment of the invention;

FIG. 3B is a table setting out the ingredients in an apple cinnamon walnut embodiment of the invention;

FIG. 3C is a table setting out the ingredients in a coconut macadamia embodiment of the invention;

FIG. 3D is a table setting out the ingredients in a cherry pecan embodiment of the invention;

FIG. 4 is a flow chart of a first embodiment of the steps for making the invention;

FIG. 5 is a flow chart of a second embodiment of the steps for making the invention;

FIG. 6 is a flow chart of a third embodiment of the steps for making the invention;

FIG. 7 is a flow chart of a fourth embodiment of the steps for making the invention;

FIG. 8 is a flow chart of a fifth embodiment of the steps for making the invention;

FIG. 9 is a flow chart of a sixth embodiment of the steps for making the invention;

FIG. 10 is a flow chart of a seventh embodiment of the steps for making the invention;

FIG. 11 is a flow chart of a eighth embodiment of the steps for making the invention;

FIG. 12A-12C is an expanded flow chart of an embodiment of the steps for making the invention; and

FIG. 13A-13C is an expanded flow chart of a further embodiment of the steps for making the invention.

### DETAILED DESCRIPTION

While the making and using of the preferred embodiments of the invention is discussed in detail below, it should be appreciated that the invention provides many applicable inventive concepts which can be embodied in a wide variety of specific contexts. Some features of the preferred embodiment of the invention shown and discussed may be simplified or exaggerated for illustrating the principles of the invention. For example, the rolling, folding, cutting steps and sub-steps of the methods described herein are described as being performed manually. Such steps and sub-steps, as well as other steps described herein may be automated using specialized machinery. For example the sheeting steps may be performed by a Rondo® sheeter.

The invention is generally directed to croissants having integrated flavorings and discrete flavorings and methods of making same, more specifically, embodiments including a banana nut croissant product, an apple cinnamon walnut croissant product, coconut macadamia nut croissant product and a cherry pecan croissant product, and is further directed to a flavored dough that can be stored frozen.

The croissant form factor structure is critical to the invention as this form factor allows the consumer of the product to handle and consume it easily as the shape and texture remains substantially intact while it is being consumed which disadvantageously is not the case with other form factors that are used as platforms to carry the flavorings. Such structure also is amenable to individual shaping and packaging of a consumable product.

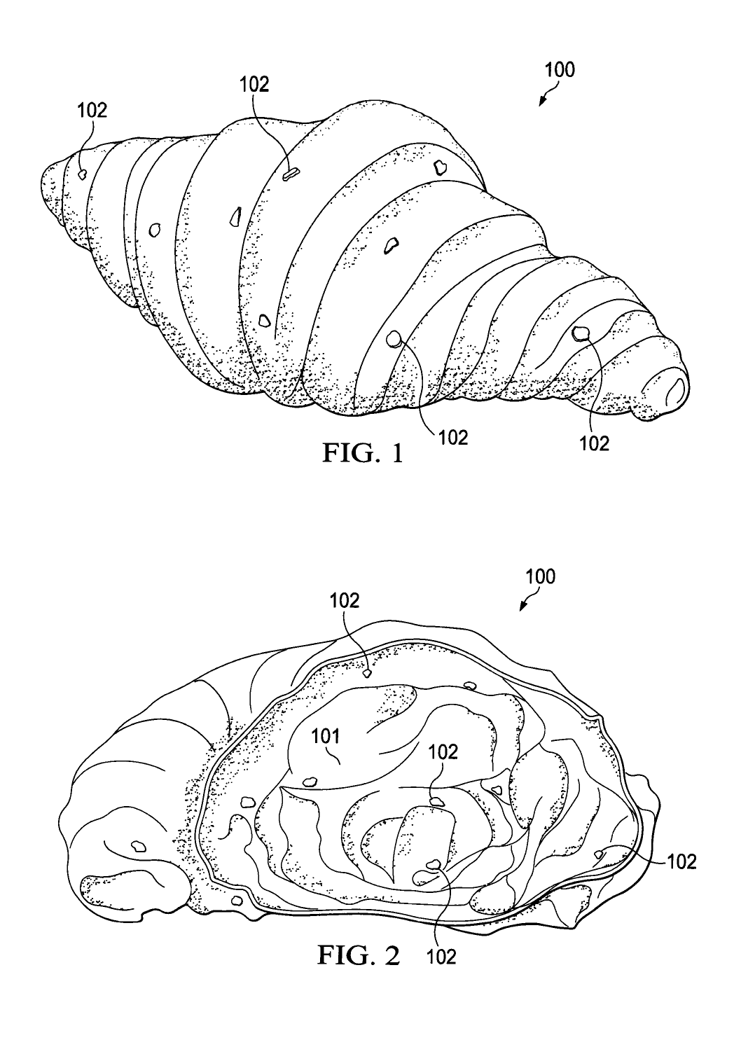

An embodiment of the invention includes base ingredients of flour, water, sugar, a leavening agent such as yeast, and a fat source, such as butter, and the flavor ingredients include an integrated flavor ingredient and a discrete flavor ingredient. As used herein, the term “integrated” refers to combine and meld the flavor ingredient homogenously throughout the butter layer or dough mixture, depending on the embodiment, as the case may be. The tern “discrete” refers to a flavor ingredient that substantially retains its particulate structure after the addition thereof into either the butter layer, dough mixture or laminated structure. As seen in FIGS. 1 and 2, after baking the invention, the integrated flavor ingredient is part of the flaky, honeycombed structure 101 of the croissant 100 and is not visibly identifiable whereas the discrete flavor ingredient is visibly identifiable in its particulate structure 102. The size of the particulate of the discrete flavor ingredient must not be so great as to cause the flaky interior of the croissant to collapse. Such particulate sizes preferably range from 1/128 inch to ⅛ inch in rough, spheroid diameter

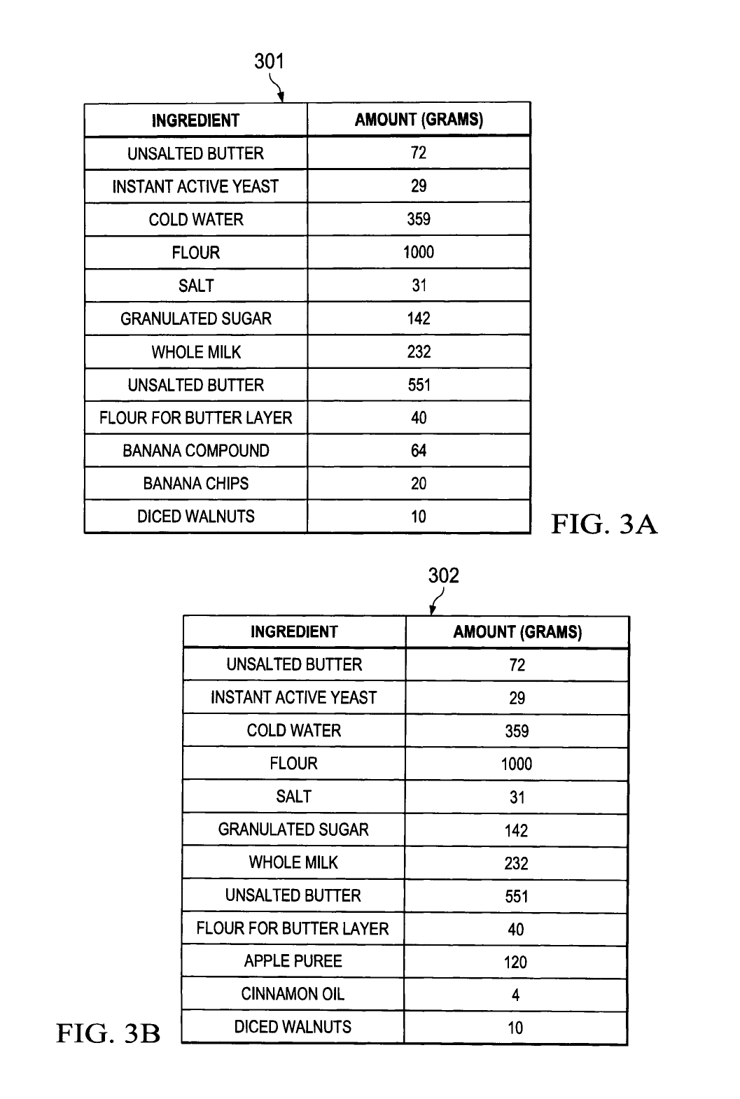

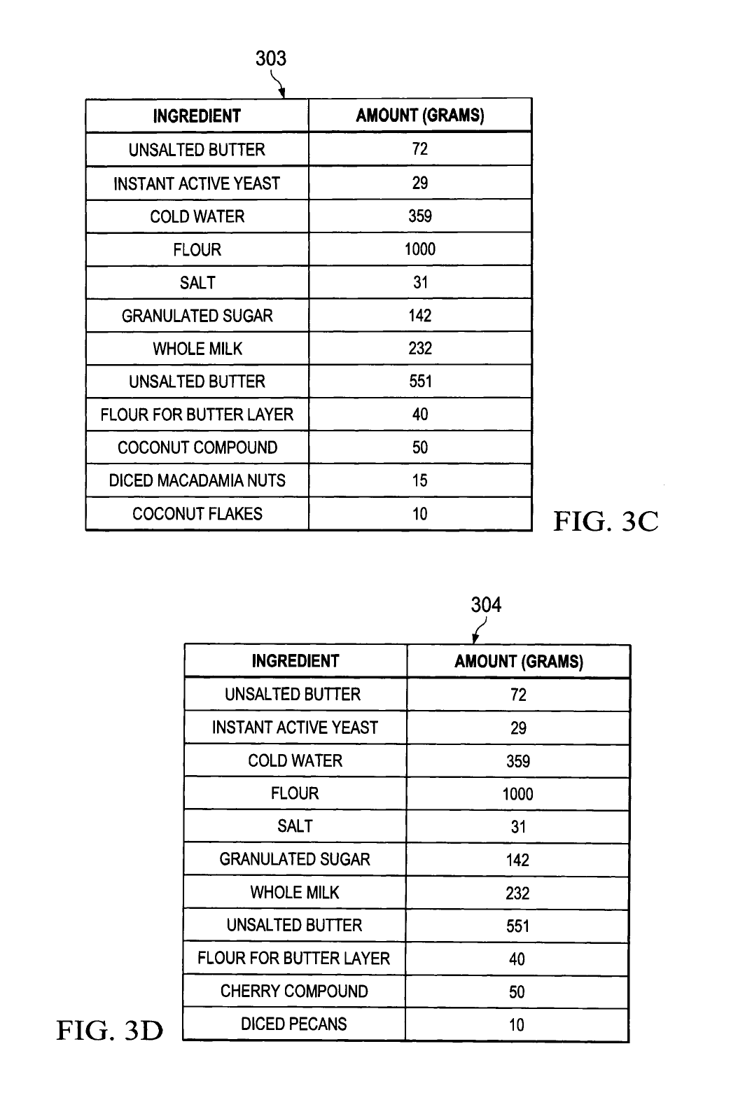

For the banana nut flavored croissant invention, the integrated flavor ingredient includes banana extract, banana compound, banana puree, dried, powderized banana chips or mashed, ripe bananas, and the discrete flavor ingredient 102 includes, e.g., chopped walnuts and/or chopped pecans. An exemplary banana compound that can be used as the integrated flavor ingredient is available at AUI Fine Foods Product Code: 01110700000 (www.auifinefoods.com/). Such compound includes sucrose, banana puree, glucose syrup, water, natural flavor, thickener, modified corn syrup, processing aid, propylene glycol, anti-oxidant, ascorbic acid, xanthan gum, natural color and beta-carotene solution. FIG. 3A sets forth a table 301 of ingredients used in making an exemplary banana nut croissant of the invention.

For the apple cinnamon walnut flavored croissant invention, the integrated flavor ingredient includes apple extract, cooked, softened apples, apple compound, apple puree or apple chips, combined with cinnamon oil, flavoring or powder. The discrete flavor ingredient 102 includes, e.g., chopped walnuts and/or chopped pecans. An exemplary apple puree that can be used as the integrated flavor ingredient is available at AUI Fine Foods Product Code: 5831010000. Such puree includes apple, sugar, and ascorbic acid as an anti-oxidant. FIG. 3B sets forth a table 302 of ingredients used in making an exemplary apple cinnamon walnut croissant of the invention.

For the coconut macadamia croissant invention, the integrated flavor ingredient includes coconut extract, coconut compound and/or coconut flakes and the discrete flavor ingredient 102 includes e.g., chopped macadamia nuts and/or coconut flakes. An exemplary coconut compound that can be used as the integrated flavor ingredient is available at AUI Fine Foods Product Code: 0111150000. Such compound includes sucrose, water, glucose syrup, modified corn starch, natural coconut flavor and iodized salt. FIG. 3C sets forth a table 303 of ingredients used in making an exemplary coconut macadamia croissant of the invention.

For the cherry pecan croissant invention, the integrated flavor ingredient includes cherry extract, cherry compound, and/or cherry flavoring and the discrete flavor ingredient 102 includes e.g., chopped pecans. An exemplary cherry compound that can be used as the integrated flavor ingredient is available at AUI Fine Foods Product Code: 0111160000. Such compound includes sucrose, glucose syrup, concentrated cherry sour juice, water, natural flavor, thickener, modified corn starch, natural flavor, fruit and vegetable color, concentrates, acidity regulator and citric acid. FIG. 3D sets forth a table 304 of ingredients used in making an exemplary cherry pecan croissant of the invention.

For the following formulations, reference is made to a method suitable for a low volume, non-industrial environment. As one skilled in the art would appreciate, each of the following can be scaled for an high volume preparation using automated machinery. For example, manual or hand folding and rolling processes can be performed using automated processes such as performed by a sheeter, automated cutter and automated roller.

The formulation below is based on a 1,000 grams of flour. The dough mixture comprises the following ingredients in substantially the following amounts: between 65 grams and 75 grams of melted unsalted butter, between 25 grams and 35 grams of instant active yeast, between 340 grams and 370 grams of cold water, approximately 1,000 grams of flour, between 25 grams and 35 grams of table salt, between 130 grams and 150 grams granulated sugar and between 200 grams and 250 grams of cold whole milk.

The butter layer is comprised of between 500 grams and 575 grams of unsalted butter at room temperature having a minimum of 82% butterfat, between 30 grams and 50 grams of all-purpose flour. Added into the butter layer is the integrated flavor ingredient and a discrete flavor ingredient. As used herein, the term “butter layer” includes a beurrage, fat, margarine, or shortening layer, each having a composition suitable to create a traditional honeycombed structured croissant similar to that created when butter is used.

In the banana nut embodiment, the integrated flavor ingredient is between 50 grams and 75 grams of banana compound and between 10 grams and 30 grams of sweetened and ground banana chips. The discrete flavor ingredient comprises between 5 grams and 30 grams of finely diced walnuts and/or 5 grams and 30 grams of finely diced pecans.

In the apple cinnamon embodiment, the integrated flavor ingredient is between 25 grams and 150 grams of apple compound, apple puree or apple chips and between 1 gram and 15 grams of cinnamon oil, flavoring or powder. The discrete flavor ingredient comprises between 5 grams and 30 grams of finely diced walnuts and/or 5 grams and 30 grams of finely diced pecans.

In the coconut macadamia embodiment, the integrated flavor ingredient is between 25 grams and 150 grams of coconut extract, coconut compound and/or coconut flakes. The discrete flavor ingredient is between 5 grams and 30 grams of chopped macadamia nuts and/or coconut flakes.

For the cherry pecan embodiment, the integrated flavor ingredient is between 10 grams and 150 grams of cherry extract, cherry compound, and/or cherry flavoring and the discrete flavor ingredient is between 5 grams and 30 grams of chopped pecans.

There are up to 8 primary steps to the invention, each having a set of sub-steps: These steps include (1) Prepare the butter layer with the integrated flavor ingredients; (2) Prepare dough mixture; (3) Lamination and folding incorporating the discrete flavor ingredients; (4) Cutting step; (5) Rolling step; (6) Optional freezing step; (7) Proofing step and (8) Baking step. In an alternative embodiment, the integrated flavor ingredient can be added to the dough mixture, provided however, care is taken not to inhibit the leavening or yeast activation. Further, steps 1 and 2 can be reversed, or can be performed at the same time as described herein.

The first step in making this embodiment is to make the butter layer as follows in the following sub-steps:

(a) Place the room temperature butter, flour, and room temperature integrated flavor ingredient in a mixing bowl fitted with a dough hook and then mix on medium speed until combined. This is the flavored butter mixture.

(b) Roll the flavored butter mixture between two pieces of parchment (or one piece folded in half), creating a rectangle-shaped package that is approximately 6 inches by 8 inches. This is the flavored butter layer.

(c) Chill the flavored butter layer in a refrigerator for at least I hour, or until uniformly pliable and the same consistency of the dough.

The second step of preparing the dough mixture (also known as the De Trempe) is comprised of the following sub-steps:

(a) Combine the milk and water in a bowl. Add the yeast, stirring to dissolve.

(b) Add the flour, sugar, water, and melted butter in a mixing bowl fitted with a dough hook.

(c) Mix on low for about 10 seconds.

(d) While the mixer is running, add the milk/water/yeast mixture.

(e) When all of the liquid has been combined, turn mixer up to medium, and allow to mix for about 1 minute, or until all of the flour has been incorporated and dough is smooth and pliable.

(f) Remove dough from mixing bowl, and knead into a smooth ball on a work surface.

(g) Cover with plastic wrap, and allow the dough to rest for 30 minutes.

(h) Uncover the dough, and roll into a rectangle. Wrap in plastic wrap and refrigerate a minimum of 2 hours, and preferably overnight. The dough will rise slightly. One skilled in the art would recognize that the first step and second step can be reversed or can be performed substantially at the same time.

The third step is to perform the lamination comprised of the following sub-steps:

(a) Remove the flavored butter layer from the refrigerator, and allow to soften slightly, to the point that is has the same pliable feel of the dough.

(b) Remove the dough from the refrigerator, and unwrap. Lightly flour the work surface. With the long side of the dough facing the maker, roll the dough into a rectangle approximately 6″×12″, making sure that the corners are nicely squared.

(c) Remove the flavored butter layer from its paper. Place the flavored butter layer, with its long side running parallel with the long side of the dough, in the center of the dough. Spread the discrete ingredients over butter. Fold the left part of the butter-less dough up and over the flavored butter layer, so that the dough reaches the middle thereof. Fold the right part of the butter-less dough up and over the flavored butter layer, so that the dough slightly overlaps the dough that was folded from the left side. With a rolling pin, seal the edges and middle of the dough, and roll to a 6″×12″ rectangle with corners squared.

(d) With the long side of the dough facing the maker, and the middle seam visible, a first turn is performed as follow: with the dough seen as being divided into 3 equal sections, the left ⅓ is grasped and then folded over the middle section. Then the right ⅓ is grasped and folded over the already-folded section. The dough thus resembles a folded letter. The ends of the dough are not to be overlapped, rather they should meet.

(e) Wrap the dough, and refrigerate for at least 2 hours. This was the first turn.

(f) Remove the dough, and again place it on a work surface with the long side facing the maker. Roll the dough into a rectangle having approximately 6 inch by 12 inch dimensions. As in step 3(d), fold the dough into ⅓'s. Wrap and return refrigerator for at least 1 hour. This is the second turn.

(g) Repeat step 3(f). This is the third turn.

(h) Repeat step 3(f). This is the fourth turn. Between each turn, the dough should be rested for at least 1 hour between each turn.

(h) After completing the fourth turn, return the wrapped dough to refrigerator, and allow to rest overnight.

The fourth step is the cutting step, comprising the following sub-steps:

(a) Remove the dough from the refrigerator, and with long side facing the maker, roll the dough to a rectangle measuring 10 inches by 12 inches.

(b) Using a round cutter such as that used to cut pizza, cut out triangles with a 4 inch base.

(c) Make a small slice in the middle of each croissant's base.

(d) Using light pressure from the palm of a hand, roll each croissant up from the base to the tip, stretching slightly to expand the slice that was made at the base.

(e) Finish forming the invention with the tip of the invention tucked just slightly under the base.

Optionally, step 6 is to freeze the formed invention or step 7 is to immediately proof (rise) and then step 8 is to bake the invention.

If this sixth step is performed, the invention should remain viable for up to 2 months to be later proofed and baked.

(a) If the invention is frozen, within about 2 months, the user can thereafter place them on a baking sheet, spaced approximately 2 inches apart.

(b) Cover lightly with plastic wrap and place in a warm area having a temperature of between 72 and 80 degrees.

(c) Allow to proof until they have doubled in size, and jiggle slightly on the tray. This should take approximately 10 hours.

The seventh step (which may be the sixth step if the dough is not frozen) is to immediately proof (rise) without freezing the invention.

(a) Place the invention on a baking sheet, each spaced approximately 2 inches apart.

(b) Cover lightly with plastic wrap and place in a warm area of between approximately 72 and 80 degrees.

(c) Allow to proof until they have doubled in size, and jiggle slightly on the tray. This should take approximately 6.

(d) In the proofing step, a proof box can be used to proof the invention. In such case, the temperature should be set at 76 degrees Fahrenheit with low humidity. Rising time from a frozen state takes approximately 9 hours. Proofing time from a thawed state takes approximately 5 hours. One skilled in the art would recognize that actual proofing times vary, depending on ambient temperature, content in proof box, and humidity levels.

The eighth step is the baking step. Optionally, an egg wash or a formulation of sugar glaze (sugar, milk, butter) can be applied to the pre-baked dough.

(a) Bake at 375 degrees F. conventional or 325 degrees Fahrenheit convection, for between approximately 22 to 25 minutes.

(b) After removing the invention from the oven, optionally finish with a light brush of simple syrup.

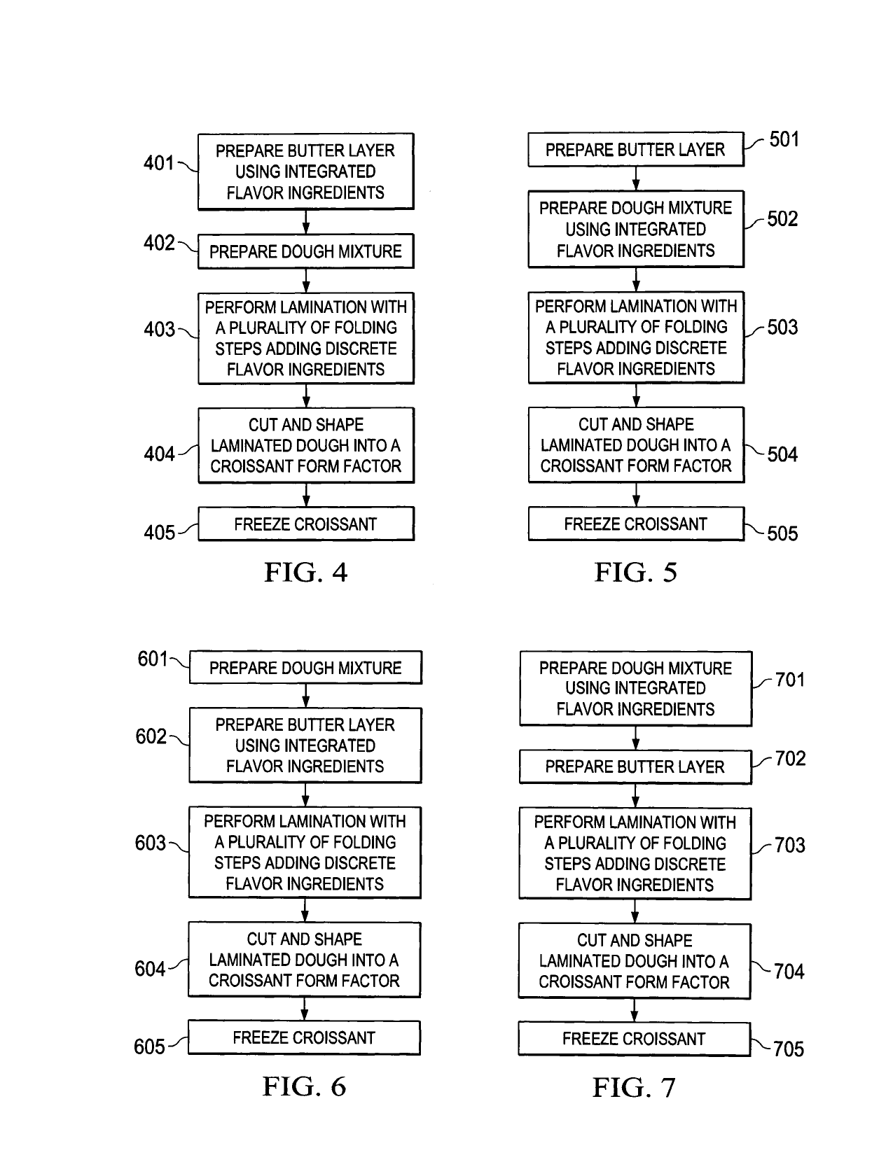

Referring to FIG. 4, a flow chart of a first embodiment of the steps for making the invention is provided.

In step 401, the butter layer using at least one integrated flavor ingredient is prepared. In step 402, the dough mixture is prepared. In step 403, the lamination and folding steps are performed adding the at least one discrete flavor ingredient. In step 404, the laminated dough is cut and shaped as a croissant. In step 405, the croissant shaped product is frozen.

In the banana nut croissant embodiment, the integrated flavor ingredient includes at least one of a banana extract, banana compound, banana puree, dried, powdered banana chips and/or mashed, ripe bananas, and the discrete flavor ingredient includes at least one of chopped walnuts and/or chopped pecans. In the apple cinnamon walnut croissant embodiment, the integrated flavor ingredient includes ate least one of apple extract, cooked, softened apples, apple compound, apple puree or apple chips, combined with cinnamon oil, flavoring or powder. The discrete flavor ingredient includes at least one of chopped walnuts and/or chopped pecans. In the coconut macadamia croissant embodiment, the integrated flavor ingredient includes ate least one of a coconut extract, coconut compound and/or coconut flakes and the discrete flavor ingredient includes at least one of chopped macadamia nuts and/or coconut flakes. In the cherry pecan croissant embodiment, the integrated flavor ingredient includes at least one of a cherry extract, cherry compound, and/or cherry flavoring and the discrete flavor ingredient includes at least one of chopped pecans or other nuts.

Referring to FIG. 5, a flow chart of a second embodiment of the steps for making the invention is provided. In step 501, the butter layer is prepared. In step 502, the dough mixture is prepared using at least one integrated flavor ingredients. In step 503, lamination and folding steps are performed, adding the discrete flavor ingredients. In step 504, the laminated dough is cut and shaped into a croissant. In step 505, the croissant is frozen.

Referring to FIG. 6, a flow chart of a third embodiment of the steps for making the invention is provided. In FIG. 6, the same steps as in FIG. 4 are performed, although the dough mixture is prepared first, then the butter layer using the at least one integrated flavor ingredient is prepared. Alternatively, both of these steps can be performed at substantially the same time. In step 603, the lamination and folding steps are performed, adding the at least one discrete flavor ingredient.

Referring to FIG. 7, a flow chart of a fourth embodiment of the steps for making the invention is provided. In FIG. 7, the same steps as in FIG. 5 are performed, although the dough mixture is prepared using the at least one integrated flavor ingredient first, then the butter layer is prepared. Alternatively, both of these steps can be performed at substantially the same time. In step 703, the lamination and folding steps are performed, adding the at least one discrete flavor ingredient.

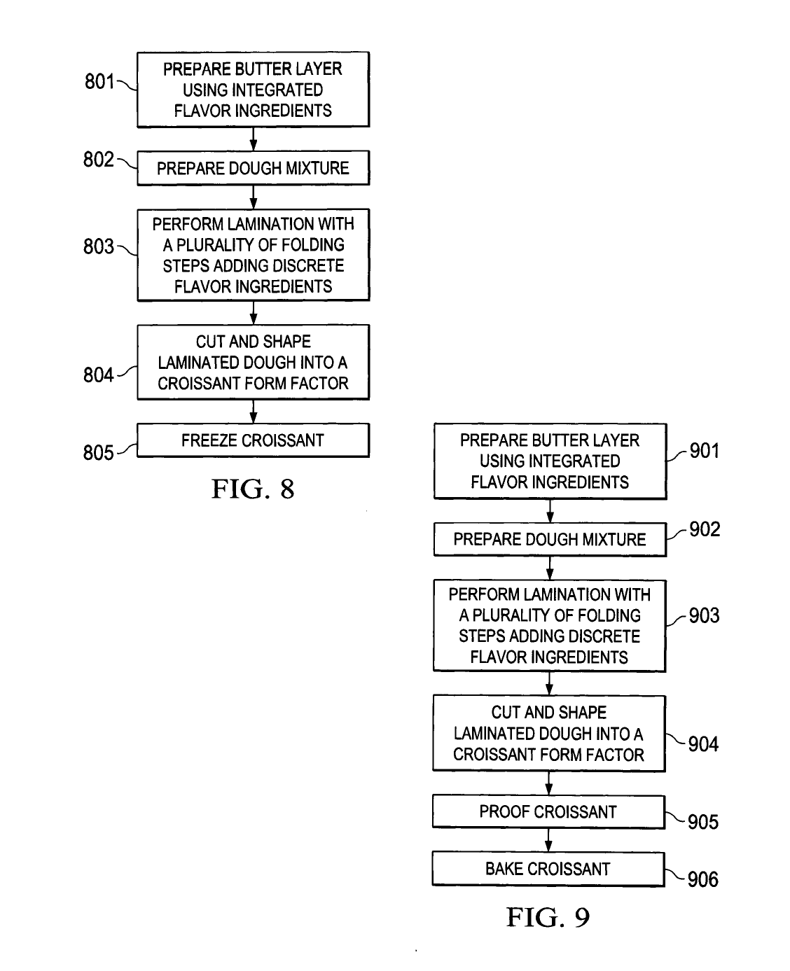

Referring to FIG. 8, a flow chart of a fifth embodiment of the steps for making the invention is provided. In step 801, the butter layer is prepared using the at least one integrated flavor ingredient. In step 802, the dough mixture is prepared. In step 803, the lamination and folding steps are performed, adding the at least one discrete flavor ingredient. In step 804, the laminated dough is cut and shaped. In step 805, the raw croissant is proofed and in step 806, the raw croissant is baked.

Referring to FIG. 9, a flow chart of a sixth embodiment of the steps for making the invention is provided. In step 901, the butter layer is prepared. In step 902, the dough mixture is prepared with at least one integrated flavor ingredient. In step 903, the lamination and folding steps are performed, adding the at least one discrete flavor ingredient. In step 904, the laminated dough is cut and shaped. In step 905, the raw croissant is proofed and in step 906, the raw croissant is baked.

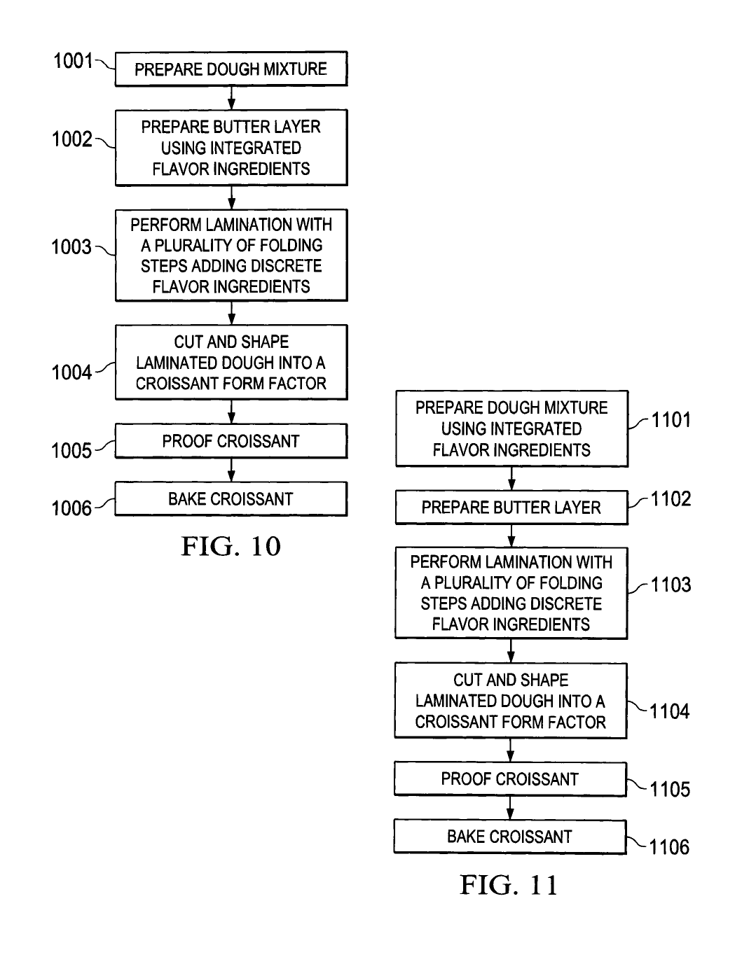

Referring to FIG. 10, a flow chart of a seventh embodiment of the steps for making the invention is provided. In FIG. 10, the same steps as in FIG. 8 are performed, although the dough mixture is prepared first, then the butter layer using the at least one integrated flavor ingredient. Alternatively, both of these steps can be performed at substantially the same time. In step 1003, the lamination and folding steps are performed, adding the at least one discrete flavor ingredient.

Referring to FIG. 11, a flow chart of a eighth embodiment of the steps for making the invention is provided. In FIG. 11, the same steps as in FIG. 9 are performed, although the dough mixture with the at least one integrated flavor ingredient is prepared first, then the butter layer is prepared. Alternatively, both of these steps can be performed at substantially the same time. In step 1103, the lamination and folding steps are performed, adding the at least one discrete flavor ingredient.

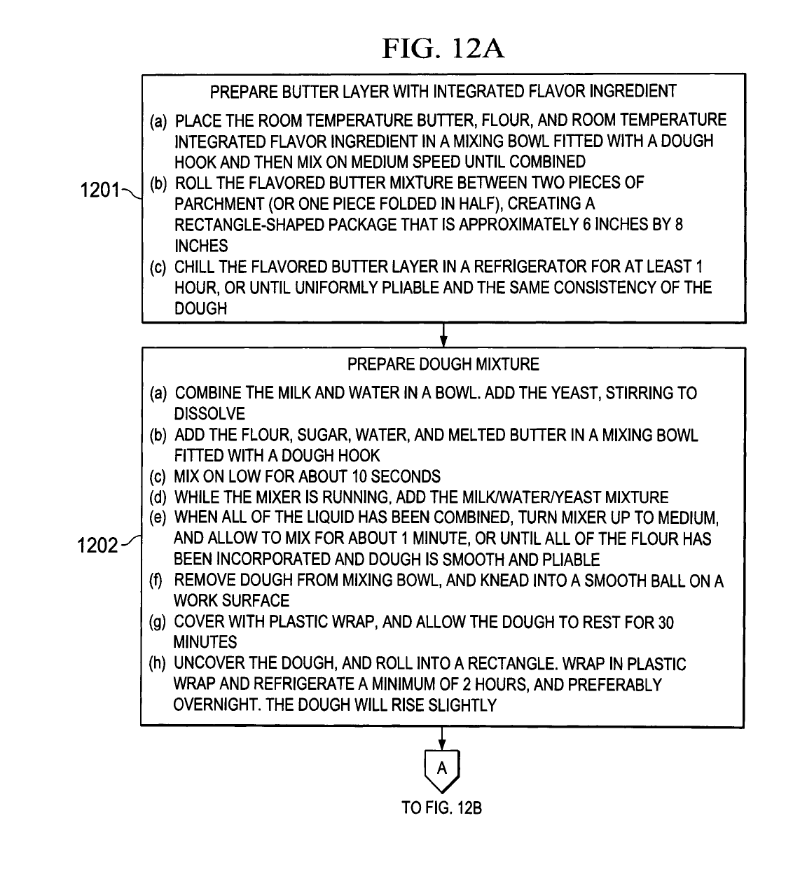

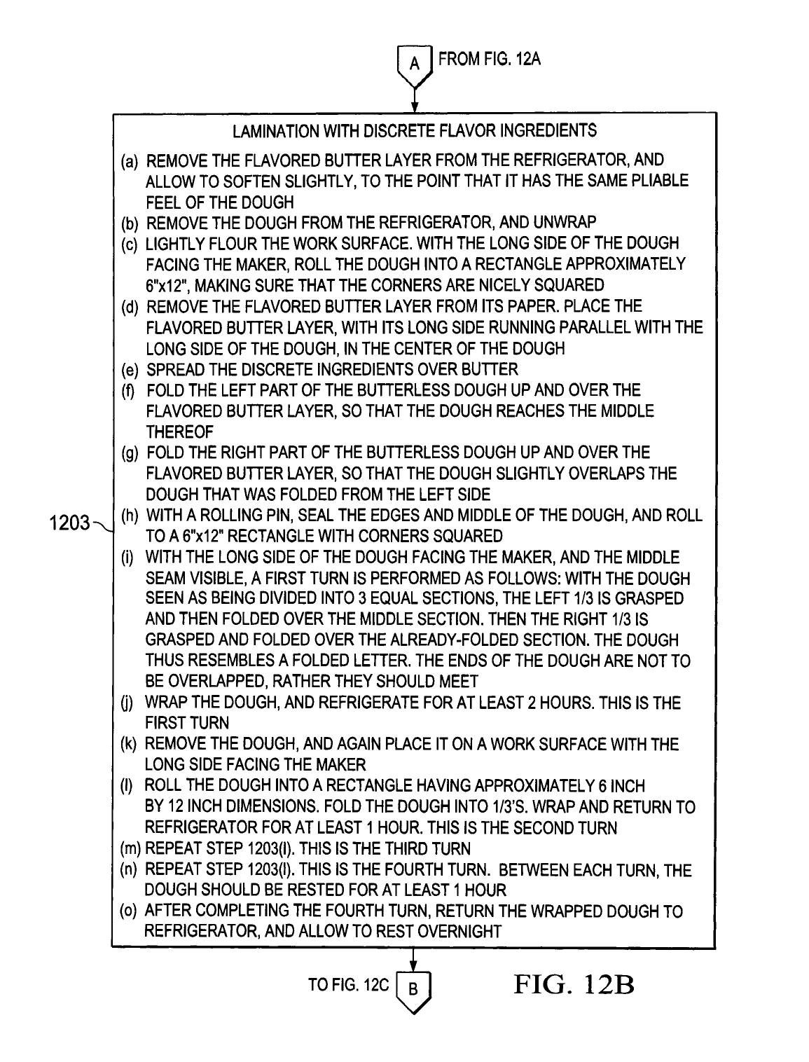

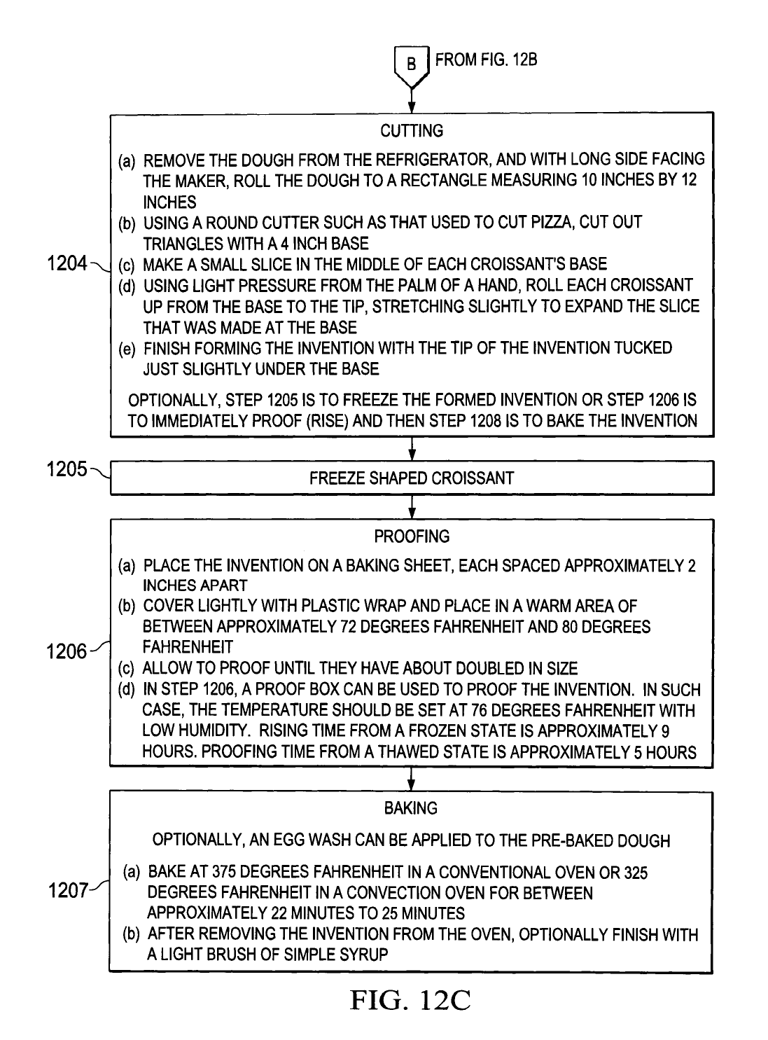

Referring to FIG. 12A-12C, an expanded flow chart of an embodiment of the steps for making the invention is provided. In step 1201, the butter layer with the integrated flavor ingredient is prepared in accordance with sub-steps 1201(a)-(c).

1201(a) Place the room temperature butter, flour, and room temperature integrated flavor ingredient in a mixing bowl fitted with a dough hook and then mix on medium speed until combined.

1201(b) Roll the flavored butter mixture between two pieces of parchment (or one piece folded in half), creating a rectangle-shaped package that is approximately 6 inches by 8 inches.

1201(c) Chill the flavored butter layer in a refrigerator for at least 1 hour, or until uniformly pliable and the same consistency of the dough.

In step 1202, the dough mixture is prepared in accordance with sub-steps 1202(a)-(h):

1202(a) Combine the milk and water in a bowl. Add the yeast, stirring to dissolve.

1202(b) Add the flour, sugar, water, and melted butter in a mixing bowl fitted with a dough hook.

1202(c) Mix on low speed for about 10 seconds.

1202(d) While the mixer is running, add the milk/water/yeast mixture.

1202(e) When all of the liquid has been combined, turn mixer up to medium, and allow to mix for about 1 minute, or until all of the flour has been incorporated and dough is smooth and pliable.

1202(f) Remove dough from mixing bowl, and knead into a smooth ball on a work surface.

1202(g) Cover with plastic wrap, and allow the dough to rest for 30 minutes.

1202(h) Uncover the dough, and roll into a rectangle. Wrap in plastic wrap and refrigerate a minimum of 2 hours, and preferably overnight. The dough will rise slightly.

In step 1203, the dough mixture and butter layer are laminated with the discrete flavor ingredients in accordance with sub-steps 1203(a)-(o).

1203(a) Remove the flavored butter layer from the refrigerator, and allow to soften slightly, to the point that is has the same pliable feel of the dough.

1203(b) Remove the dough from the refrigerator, and unwrap.

1203(c) Lightly flour the work surface. With the long side of the dough facing the maker, roll the dough into a rectangle approximately 6″×12″, making sure that the corners are nicely squared.

1203(d) Remove the flavored butter layer from its paper. Place the flavored butter layer, with its long side running parallel with the long side of the dough, in the center of the dough.

1203(e) Spread the discrete ingredients over butter.

1203(f) Fold the left part of the butter-less dough up and over the flavored butter layer, so that the dough reaches the middle thereof.

1203(g) Fold the right part of the butter-less dough up and over the flavored butter layer, so that the dough slightly overlaps the dough that was folded from the left side.

1203(h) With a rolling pin, seal the edges and middle of the dough, and roll to a 6″×12″ rectangle with corners squared.

1203(i) With the long side of the dough facing the maker, and the middle seam visible, a first turn is performed as follow: with the dough seen as being divided into 3 equal sections, the left ⅓ is grasped and then folded over the middle section. Then the right ⅓ is grasped and folded over the already-folded section. The dough thus resembles a folded letter. The ends of the dough are not to be overlapped, rather they should meet.

1203(j) Wrap the dough, and refrigerate for at least 2 hours. This is the first turn. 1203(k) Remove the dough, and again place it on a work surface with the long side facing the maker.

1203(l) Roll the dough into a rectangle having approximately 6 inch by 12 inch dimensions. Fold the dough into ⅓'s. Wrap and return refrigerator for at least 1 hour. This is the second turn.

1203(m) Repeat step 1203(l). This is the third turn.

1203(n) Repeat step 3(l). This is the fourth turn. Between each turn, the dough should be rested for at least 1 hour between each turn.

1203(o) After completing the fourth turn, return the wrapped dough to refrigerator, and allow to rest overnight.

In step 1204, the laminated and folded dough is cut as described in sub-steps 1204(a)-(e).

1204(a) Remove the dough from the refrigerator, and with long side facing the maker, roll the dough to a rectangle measuring 10 inches by 12 inches.

1204(b) Using a round cutter such as that used to cut pizza, cut out triangles with a 4 inch base.

1204(c) Make a small slice in the middle of each croissant's base.

1204(d) Using light pressure from the palm of a hand, roll each croissant up from the base to the tip, stretching slightly to expand the slice that was made at the base.

1204(e) Finish forming the invention with the tip of the invention tucked just slightly under the base.

Optionally, step 1205 is to freeze the formed invention or step 1206 is to immediately proof (rise) and then step 1207 is to bake the invention.

Step 1205 is to place the raw croissant in a freezer having a temperature below 32 degrees Fahrenheit. Alternatively, the raw croissant can be partially proofed or par baked and then frozen.

Step 1206 is to proof the raw croissant in accordance with sub-steps 1206(a)-(d).

1206(a) Place the invention on a baking sheet, each spaced approximately 2 inches apart.

1206(b) Cover raw croissants lightly with plastic wrap and place in a warm area of between approximately 72 degrees Fahrenheit and 80 degrees Fahrenheit.

1206(c) Allow to proof until they have about doubled in size. This should take approximately 6 hours.

1206(d) In step 1206, a proof box can be used to proof the invention. In such case, the temperature of the proof box should be set at 76 degrees Fahrenheit with low humidity. Rising time from a frozen state is approximately 9 hours. Proofing time from a thawed state is approximately 5 hours

In step 1207, the raw, proofed croissant is baked in accordance with steps 1207(a)-(b). Optionally, an egg wash can be applied to the pre-baked dough.

1207(a) Bake at 375 degrees Fahrenheit in a conventional oven or 325 degrees Fahrenheit in a convection oven for between approximately 22 to 25 minutes.

1207(b) After removing the invention from the oven, optionally finish with a light brush of simple syrup.

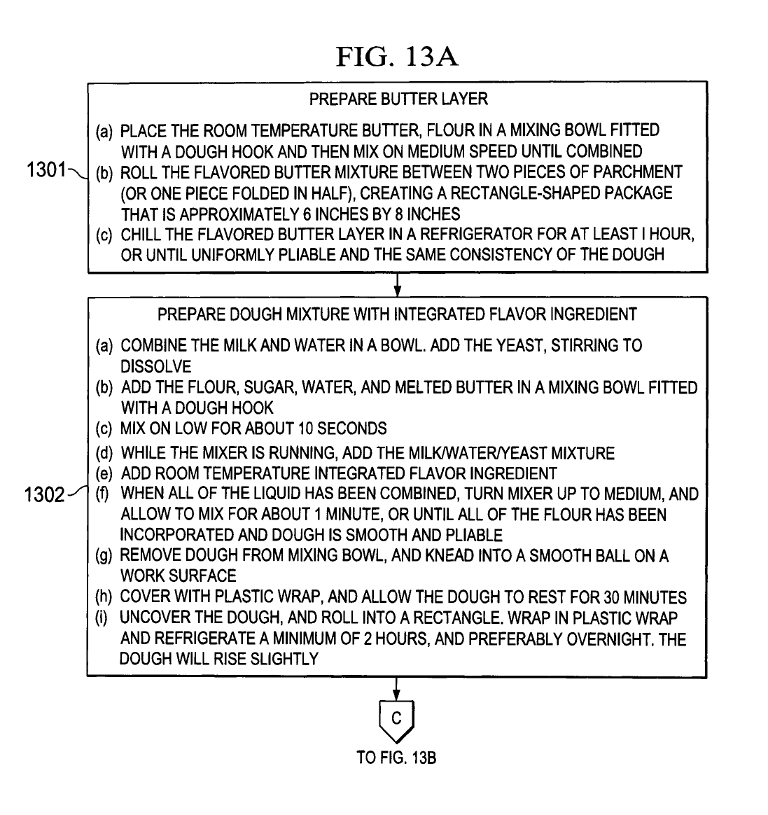

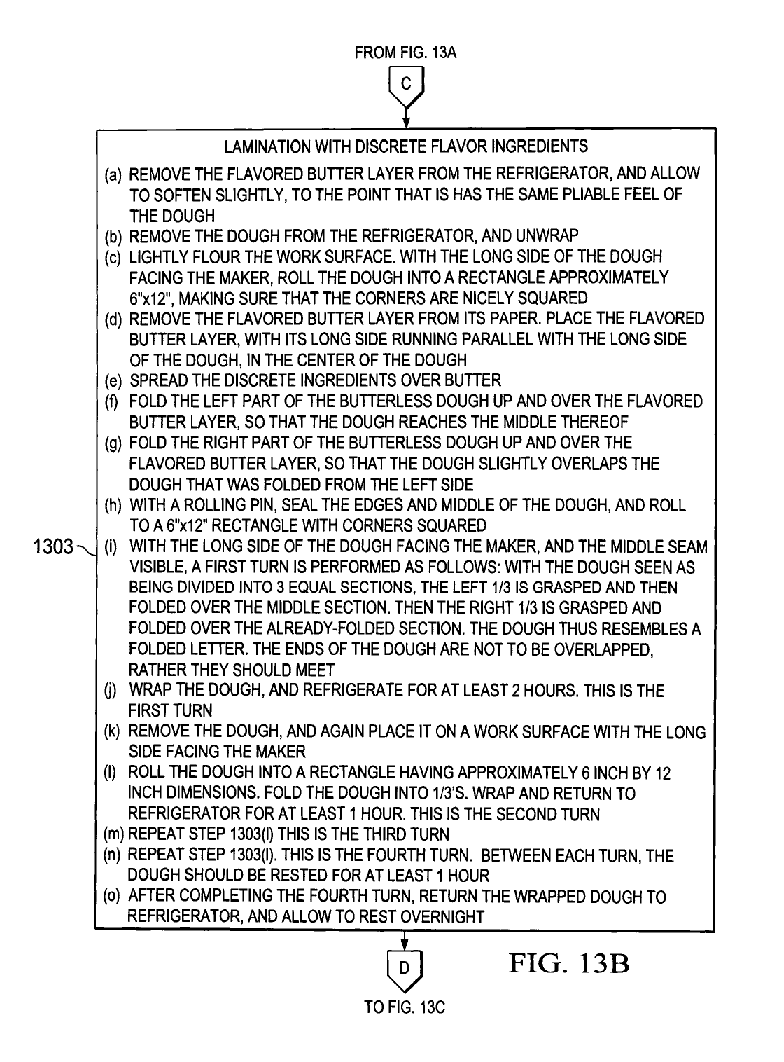

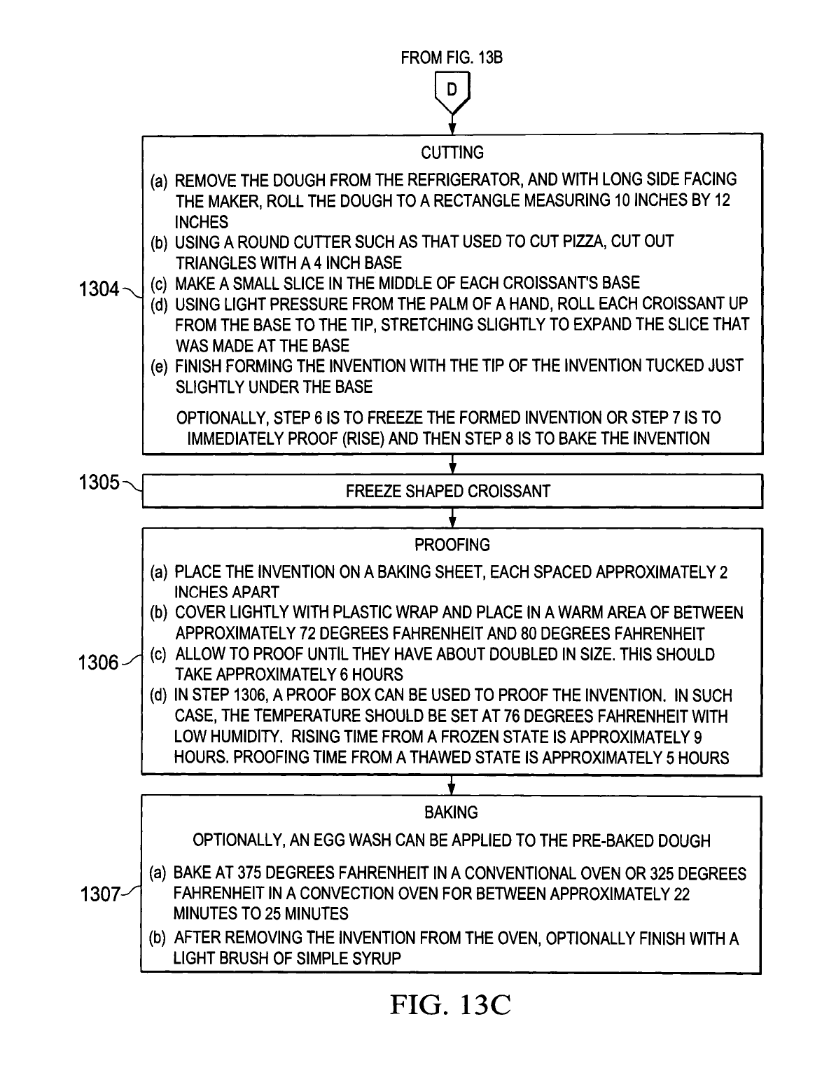

Referring to FIG. 13A-13C, an expanded flow chart of a further embodiment of the steps for making the invention is provided wherein the integrated flavor ingredient is in the dough.

In step 1301, the butter layer is prepared in accordance with steps 1301(a)-(c).

1301(a) Place the room temperature butter, flour in a mixing bowl fitted with a dough hook and then mix on medium speed until combined.

1301(b) Roll the flavored butter mixture between two pieces of parchment (or one piece folded in half), creating a rectangle-shaped package that is approximately 6 inches by 8 inches.

1301(c) Chill the flavored butter layer in a refrigerator for at least I hour, or until uniformly pliable and the same consistency of the dough.

In step 1302, prepare the dough mixture with integrated flavor ingredient in accordance with sub-steps 1302(a)-(i)

1302(a) Combine the milk and water in a bowl. Add the yeast, stirring to dissolve.

1302(b) Add the flour, sugar, water, and melted butter in a mixing bowl fitted with a dough hook.

1302(c) Mix on low for about 10 seconds.

1302(d) While the mixer is running, add the milk/water/yeast mixture.

1302(e) Add room temperature integrated flavor ingredient

1302(f) When all of the liquid has been combined, turn mixer up to medium, and allow to mix for about 1 minute, or until all of the flour has been incorporated and dough is smooth and pliable.

1302(g) Remove dough from mixing bowl, and knead into a smooth ball on a work surface.

1302(h) Cover with plastic wrap, and allow the dough to rest for 30 minutes.

1302(i) Uncover the dough, and roll into a rectangle. Wrap in plastic wrap and refrigerate a minimum of 2 hours, and preferably overnight. The dough will rise slightly.

In step 1303 the dough mixture and butter layer are laminated with the discrete flavor ingredients in accordance with steps 1303(a)-(o).

1303(a) Remove the flavored butter layer from the refrigerator, and allow to soften slightly, to the point that is has the same pliable feel of the dough.

1303(b) Remove the dough from the refrigerator, and unwrap.

1303(c) Lightly flour the work surface. With the long side of the dough facing the maker, roll the dough into a rectangle approximately 6″×12″, making sure that the corners are squared.

1303(d) Remove the flavored butter layer from its paper. Place the flavored butter layer, with its long side running parallel with the long side of the dough, in the center of the dough.

1303(e) Spread the discrete ingredients over butter.

1303(f) Fold the left part of the butterless dough up and over the flavored butter layer, so that the dough reaches the middle thereof.

1303(g) Fold the right part of the butterless dough up and over the flavored butter layer, so that the dough slightly overlaps the dough that was folded from the left side. (h) With a rolling pin, seal the edges and middle of the dough, and roll to a 6″×12″ rectangle with corners squared.

1303(i) With the long side of the dough facing the maker, and the middle seam visible, a first turn is performed as follow: with the dough seen as being divided into 3 equal sections, the left ⅓ is grasped and then folded over the middle section. Then the right ⅓ is grasped and folded over the already-folded section. The dough thus resembles a folded letter. The ends of the dough are not to be overlapped, rather they should meet.

1303(j) Wrap the dough, and refrigerate for at least 2 hours. This is the first turn.

1303(k) Remove the dough, and again place it on a work surface with the long side facing the maker.

1303(l) Roll the dough into a rectangle having approximately 6 inch by 12 inch dimensions. Fold the dough into ⅓'s. Wrap and return refrigerator for at least 1 hour. This is the second turn.

1303(m) Repeat step 1303(l). This is the third turn.

1303(n) Repeat step 1303(l). This is the fourth turn. Between each turn, the dough should be rested for at least 1 hour between each turn.

1303(o) After completing the fourth turn, return the wrapped dough to refrigerator, and allow to rest overnight.

In step 1304, the laminated dough mixture and butter layer are cut in accordance with sub-steps 1303(a)-(e).

1304(a) Remove the dough from the refrigerator, and with long side facing the maker, roll the dough to a rectangle measuring 10 inches by 12 inches.

1304(b) Using a round cutter such as that used to cut pizza, cut out triangles with a 4 inch base.

1304(c) Make a small slice in the middle of each croissant's base.

1304(d) Using light pressure from the palm of a hand, roll each croissant up from the base to the tip, stretching slightly to expand the slice that was made at the base.

1304(e) Finish forming the invention with the tip of the invention tucked just slightly under the base.

Optionally, step 1305 is to freeze the formed invention or step 1306 is to immediately proof (rise) and then step 1307 is to bake the invention.

In step 1305, the raw croissant is frozen at a temperature of less than 32 degrees Fahrenheit. Alternatively, the raw croissant can be partially proofed or par baked and then frozen.

In step 1306, the raw croissant is proofed in accordance with sub-steps 1306(a)-(d).

1306(a) Place the invention on a baking sheet, each spaced approximately 2 inches apart.

1306(b) Cover lightly with plastic wrap and place in a warm area of between approximately 72 degrees Fahrenheit and 80 degrees Fahrenheit.

1306(c) Allow to proof until they have about doubled in size. This should take approximately 6 hours.

1306(d) In step 1307, a proof box can be used to proof the invention. In such case, the temperature should be set at 76 degrees F. with low humidity. Rising time from a frozen state is approximately 9 hours. Proofing time from a thawed state is approximately 5 hours

Step 1307 is baking the raw, proofed croissant in accordance with sub-steps 1307(a)-(b). Optionally, an egg wash can be applied to the pre-baked dough.

1307(a) Bake in an oven set at 375 degrees F. conventional oven or 325 degrees F. convection oven for between approximately 22 to 25 minutes.

1307(b) After removing the invention from the oven, optionally finish with a light brush of simple syrup

In each of FIGS. 4-13, reference is made to the at least one integrated flavor ingredient and the at least one discrete flavor ingredient. To optimize the organoleptic qualities of the invention, the invention must contain both the at least one integrated flavor ingredient and the at least one discrete flavor ingredient. In the banana nut croissant embodiment, the integrated flavor ingredient includes at least one of a banana extract, banana compound, banana puree, dried, powdered banana chips and/or mashed, ripe bananas, and the discrete flavor ingredient includes at least one of chopped walnuts and/or chopped pecans. In the apple cinnamon walnut croissant embodiment, the integrated flavor ingredient includes ate least one of apple extract, cooked, softened apples, apple compound, apple puree or apple chips, combined with cinnamon oil, flavoring or powder. The discrete flavor ingredient includes at least one of chopped walnuts and/or chopped pecans. In the coconut macadamia croissant embodiment, the integrated flavor ingredient includes ate least one of a coconut extract, coconut compound and/or coconut flakes and the discrete flavor ingredient includes at least one of chopped macadamia nuts and/or coconut flakes. In the cherry pecan croissant embodiment, the integrated flavor ingredient includes at least one of a cherry extract, cherry compound, and/or cherry flavoring and the discrete flavor ingredient includes at least one of chopped pecans or other nuts.

In each of the foregoing aspects and embodiments, a par baked dough or frozen dough can be prepared by adding additional preservatives and ingredients, and by partially proofing before quick freezing the dough. The frozen dough can then be thawed as part of the full proofing process prior to baking. Preservatives include Ascorbic acid, for example, which is also known as vitamin C, which can both assist dough in the rising stage and strengthen starches when used in small quantities. Ascorbic acid lowers pH levels and stops the enzymatic process that makes croissants go bad. Polysorbate 60 is an emulsifier and prevents croissants from getting stale, and lecithin, an antioxidant that stops oxidation and prevents the par baked croissants from going rancid, can also fall within this category. Calcium propionate and sodium propionate are two of the most common additives in dough sold commercially. Both are compounds of calcium or sodium salts and propionic acid, and their main function is to prohibit mold growth. They work by making the chemical structure hostile to mold growth, even though it is otherwise an almost ideal environment for decomposition. Cultured whey performs in almost the same way. Sodium bisulfite and sulfur dioxide are additives that prevent bacterial growth.

Frozen, par baked and fresh flavored croissants according to the present invention may further include peach extract as the integrated flavor ingredient and pecans as the discrete flavor ingredient, with toffee flavoring as the integrated flavor ingredient and macadamia nut as the discrete flavor ingredient and vanilla extract as the integrated flavor ingredient and chopped peanuts as the discrete flavor ingredient.

Although embodiments of the invention have been described above, it is not limited thereto, and it will be apparent to persons skilled in the art that numerous modifications and variations form part of the present invention insofar as they do not depart from the spirit, nature, and scope of the claimed and described invention. For example, differing amounts of the base ingredients and the flavor ingredients can be used in the various formulations.

I claim:

1. An edible product, comprising:
a dough composition having the form factor of a croissant,
the dough composition being formed of laminated dough layers and butter layers, the butter layer including at least one integrated flavor ingredient, and
within the dough composition, including at least one discrete flavor ingredient.

2. The edible product of claim 1, wherein the at least one integrated flavor ingredient is a banana compound and the at least one discrete flavor ingredient are diced walnuts, the edible product being a banana nut croissant.

3. The edible product of claim 1, wherein the at least one integrated flavor ingredient is a banana compound and the at least one discrete flavor ingredient are diced walnuts and chopped pecans, the edible product being a banana nut croissant.

4. The edible product of claim 1, wherein the at least one integrated flavor ingredient is an apple puree and cinnamon flavoring and the at least one discrete flavor ingredient are diced walnuts, the edible product being an apple cinnamon walnut croissant.

5. The edible product of claim 1, the at least one integrated flavor ingredient is a coconut compound and the at least one discrete flavor ingredient are chopped macadamia nuts, the edible product being a coconut macadamia croissant.

6. The edible product of claim 1, wherein the at least one integrated flavor ingredient is a cherry compound and the at least one discrete flavor ingredient are chopped pecans, the edible product being a cherry pecan croissant.

7. A method of making an edible product comprising the steps of:
preparing a butter layer with at least one integrated flavor ingredient;
preparing a dough mixture;
laminating the butter layer with the dough mixture using a plurality of folding steps;
adding discrete flavor ingredients during the laminating step;
cutting the laminated dough and butter layer in the shape of a triangle; and
rolling up the cut dough in the shape of a triangle into a croissant.

8. The method of claim 7, further comprising freezing the croissant.

9. The method of claim 8, further comprising the steps of:
thawing the croissant;
proofing the croissant; and
baking the croissant.

10. The method of claim 7, wherein the at least one integrated flavor ingredient is a banana compound and the at least one discrete flavor ingredient are diced walnuts.

11. The method of claim 7, wherein the at least one integrated flavor ingredient is a banana compound and the at least one discrete flavor ingredient are diced walnuts and chopped pecans.

12. The method of claim 7, wherein the at least one integrated flavor ingredient is an apple puree and cinnamon flavoring and the at least one discrete flavor ingredient are diced walnuts

13. The method of claim 7, wherein the at least one integrated flavor ingredient is a coconut compound and the at least one discrete flavor ingredient are chopped macadamia nuts.

14. The method of claim 7, wherein the at least one integrated flavor ingredient is a cherry compound and the at least one discrete flavor ingredient are chopped pecans.

15. A method of making an edible product comprising the steps of:
preparing a butter layer;
preparing a dough mixture with at least one integrated flavor ingredient;
laminating the butter layer with the dough mixture using a plurality of folding steps;
adding discrete flavor ingredients during the laminating step;
cutting the laminated dough and butter layer in the shape of a triangle; and
rolling up the cut dough in the shape of a triangle into a croissant.

16. The method of claim 15, wherein the at least one integrated flavor ingredient is a banana compound and the at least one discrete flavor ingredient are diced walnuts.

17. The method of claim 15, wherein the at least one integrated flavor ingredient is a banana compound and the at least one discrete flavor ingredient are diced walnuts and chopped pecans.

18. The method of claim 15, wherein the at least one integrated flavor ingredient is an apple puree and cinnamon flavoring and the at least one discrete flavor ingredient are diced walnuts

19. The method of claim 15, wherein the at least one integrated flavor ingredient is a coconut compound and the at least one discrete flavor ingredient are chopped macadamia nuts.

20. The method of claim 15, wherein the at least one integrated flavor ingredient is a cherry compound and the at least one discrete flavor ingredient are chopped pecans.
